(19) United States
(12) Patent Application Publication
(10) Pub. No.: US 2026/0305911 A1
(43) Pub. Date: Oct. 8, 2026

(54) WALK-OFF CARPET

(71) Applicant: ALADDIN MANUFACTURING CORPORATION, Calhoun, GA (US)

(72) Inventors: Erika MORENO, Calhoun, GA (US); Margaret Archelle BAILEY, Calhoun, GA (US); Michael E. BELL, Calhoun, GA (US); Michael GEARHART, Calhoun, GA (US)

(21) Appl. No.: 19/481,427

(22) PCT Filed: Apr. 25, 2024
(86) PCT No.: PCT/IB2024/054037

§ 371 Date: Nov. 4, 2025

Related U.S. Application Data
(60) Provisional application No. 63/500,280, filed on May 5, 2023.

(51) Int. Cl. A47L 23/26; B32B 5/06; D02G 3/04; D02G 3/36; D02G 3/44; D05C 17/02

(52) U.S. Cl. CPC A47L 23/266; B32B 5/073; D02G 3/045; D02G 3/36; D02G 3/445; D05C 17/026; B32B 2262/0253; B32B 2262/0261; B32B 2262/12; B32B 2305/026; B32B 2307/202; B32B 2471/02; D10B 2321/022; D10B 2331/02; D10B 2503/04

(57) ABSTRACT

A walk-off carpet or mat may be made by tufting a yam through a primary backing where the yam is comprised of a plurality of first polymer filaments, and second polymer filaments where the first polymer has a higher melting temperature than the second polymer. The scraper elements may be formed at the top of the pile or between the loops of the carpet or mat by melting or partially melting the filaments of the lower melting polymer. In another embodiment, the yarn may be made of core and sheath filaments where the scraper element is the core made from a polymer with a higher melting temperature than the sheath. The scraper elements may be created and exposed in the pile and at the top of the pile of the walk-off carpet or mat by melting or partially melting the sheaths from the cores.

The present invention relates to a walk-off carpet or mat, which is sometimes known as a scraper carpet, and methods of making the carpet or mat.

### BACKGROUND

Carpets and mats with stiff piles have been used to scrape mud, dirt, dust, and other particulate matter from shoes.

For example, EP 0 965 300 A1 discloses a dust control mat that has a fibre layer including a substrate and a tufted layer, and a rubber backing. The tufted layer includes tufts of a synthetic monofilament yarn, a high twist nylon yarn and a cotton blend yarn having good moisture absorbing characteristics.

Also, GB26701/75A discloses a carpet that is characterized in that it has pile or tufts that comprise 75 to 98% by weight of yarns of a first carpet fibres and from 2 to 25% by weight of second fibres or filaments which are not part of said yarns and are stiffer than said yarns. The second fibres are intended to act on dirt scrapers. The first fibres can be nylon, acrylic, regenerated cellulose, wool, polyester, cotton or polypropylene fibres or a mixture of two or more of these and generally are of less than 30 d tex per filament, for example 10 to 20 d tex per filament. The first fibres are formed into yarns for example of 200 to 1,000 tex by conventional spinning. The second fibres are preferably heavy monofilaments, for example of nylon, polyester or unplasticized polypropylene of 30 to 300 tex. Metallic fibres or filaments of similar stiffness can also be used. Alternatively, the second fibres can be in the form of a twisted yarn which has been resinated to stiffen it. The second fibres may appear in each row of the first fibres, or in alternate rows or less frequently.

In some scraper mats, nylon may be a preferred yarn since it is durable and can be made to be stiff so that it may scrape the bottom of a shoe better than other natural or synthetic yarns. In some cases, then, it may be preferable to have a yarn made of nylon filament with a high denier. This may be accomplished by either having more filaments in the yarn where each filament has a relatively small cross-section, or by having fewer filaments with each filament having a relatively large cross-section. In some cases, the latter may be preferred to provide an even stronger scraping action since nylon filaments with larger cross-sections are stiffer than nylon filaments with smaller cross-section. It may also be desirable to create a high-profile pile that may offer more loft so that it may provide more scraping as the shoe descends and lifts.

However, stiffer yarns are more difficult to tuft in commercial tufting machines because of their high yarn weight, low tenacity, and they display a larger friction resistance than less stiff yarns. Similarly, stiffer yarns require a strong backing that can retain the tufts, which usually requires a thicker backing. In many cases, the backing is made from a natural or synthetic rubber that may provide an undesirable loss of flexibility as compared to mats with thinner backings. In some cases, the backings may be impervious to the point that water may be trapped under the backing.

Therefore, there exists a need for a scraper carpet or mat with scraper elements with better scraping and stiffness qualities, but that is made from yarn that is easy to tuft.

### BRIEF SUMMARY

To this aim, the invention relates to creating a walk-off carpet with a high-profile, stiff pile with scraper elements exposed at the crowns of the loops of the carpet.

A griege product tufted with yarns that contain a higher melting filament and a lower melting filament may be subjected to heat such that some portion of the lower melting filaments melt or partially melt. A portion of the melted lower melting polymer may wick around adjoining filaments of the same loop or of other loops. When cooled, some portion of these previously melted portions become structures between filaments and/or loops to stiffen the loops. Other portions may become irregularly shaped structures at or near the crowns of loops. Taken together, the structures stiffen the pile and present features that make the carpet a walk-off carpet capable of scraping dust and dirt from shoes and other articles that contact it.

In a first independent aspect, the invention relates to a walk-off carpet or mat, comprising: a backing comprising a face and a back; a yarn tufted through the backing, wherein a first portion of the yarn is a loop and is disposed on the face of the backing and a second portion of the yarn comprises a backstitching and is disposed on the back of the backing; and wherein the pile of the yarn comprises a first polymer and the backstitching comprises the first polymer and a second polymer that has a lower melting temperature than the first polymer.

In a second independent aspect, the invention relates to a walk-off carpet or mat, comprising: a backing having a first side and a second side; a multicomponent yarn tufted through the backing having at least one pile loop on the first side and at least one backstitch on the second side; wherein a portion of the pile loop consists of a first polymer; and a portion of the backstitch consists of the first polymer and a second polymer.

In a third independent aspect, the invention relates to the walk-off carpet or mat of any preceding aspect, wherein the carpet or mat is made by tufting the yarn through the primary backing and exposing the pile to heat to at least partially melt the lower melting polymer.

In a fourth independent aspect, the invention relates to a method of making a walk-off carpet or mat, comprising: providing a backing comprising a face and a back; providing a multicomponent yarn comprised of a first polymer and a second polymer, wherein the first polymer has a first melting temperature and the second polymer has a second melting temperature that is higher than the first melting temperature; tufting the multicomponent yarn through the backing; exposing the portion of the multicomponent yarn exposed on the face to a heat source that warms the multicomponent yarn to a temperature that is higher than the first melting temperature.

In a fifth independent aspect, the invention relates to a walk-off carpet or mat, comprising: a backing comprising a face and a back; a yarn tufted through the backing, wherein a first portion of the yarn is the pile and is disposed on the face of the backing and a second portion of the yarn comprises the backstitching and is disposed on the back of the backing; and wherein the pile of the yarn consists of a first polymer and the backstitching comprises the first polymer and a second polymer that has a lower melting temperature than the first polymer.

In a sixth independent aspect, the invention relates to a walk-off carpet or mat, comprising: a backing having a first side and a second side; a multicomponent yarn tufted through the backing having at least one pile loop on the first side and at least one backstitch on the second side; wherein a portion of the pile loop consists of a first polymer; and a portion of the backstitch consists of the first polymer and a second polymer.

In a seventh independent aspect, the invention relates to a method of making a walk-off carpet or mat, comprising: providing a backing comprising a face and a back; providing a multicomponent yarn comprised of a first polymer and a second polymer, wherein the first polymer has a first melting temperature and the second polymer has a second melting temperature that is higher than the first melting temperature; tufting the multicomponent yarn through the backing; exposing the portion of the multicomponent yarn exposed on the face to a heat source that warms the multicomponent yarn to a temperature that is higher than the first melting temperature.

### BRIEF DESCRIPTION OF THE DRAWINGS

With the intention of better showing the characteristics of the invention, herein after, as an example without any limitative character, some preferred embodiments are described, with reference to the accompanying drawings, wherein:

FIG. 1 illustrates a segment of a prior art walk-off carpet.

FIG. 2 illustrates a bundle of filaments in a yarn according to the invention.

FIG. 3 illustrates a bundle of trilobal filaments in a yarn according to the invention.

FIG. 4 illustrates a bundle of core and sheath filaments in a yarn according to the invention.

FIG. 5 illustrates a segment of a walk-off carpet according to the invention.

FIG. 6 illustrates a segment of a walk-off carpet according to the invention.

FIG. 7 illustrates a segment of a walk-off carpet according to the invention.

FIG. 8 illustrates a segment of a walk-off carpet according to the invention.

FIG. 9 illustrates a walk-off carpet according to the invention.

FIG. 10 illustrates a walk-off carpet according to the invention.

### DETAILED DESCRPTION

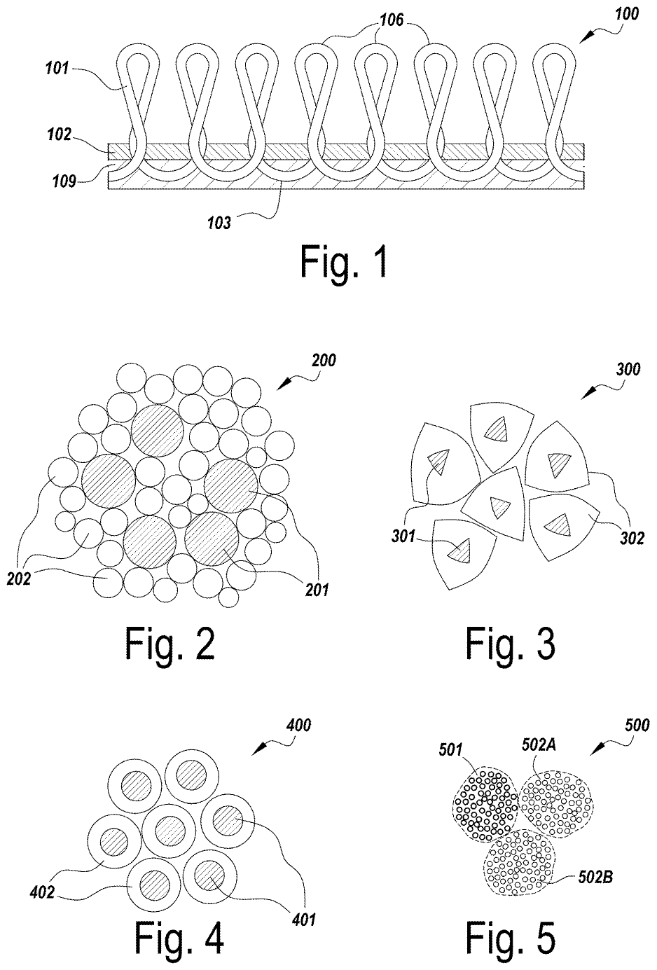

As may be known to those of ordinary skill in the art, prior art walk-off carpets and mats may be tufted with filaments that may be stiff so that they contact and scrape particulate matter away from shoes that walk across the carpets. FIG. 1 illustrates a prior art walk-off carpet 100 that has loops 101 of yarn, a primary backing 102, and a secondary backing 109. The loops 101 may be stiff so that the crowns 106 of the loops 101 act as scraper elements. The backstitches 103 of the loops 101 may be secured within the walk-off carpet 100 by being embedded within the secondary backing 109, which may be made of a thick rubber or a latex.

As used herein, the term scraper element may be any structure that makes the pile of the mat or carpet more rigid and/or any structure that produces a coarse feature in the pile of the mat or carpet. That is to say that scraper elements stiffen the pile of the mat or carpet so they contact footwear longer, and scraper elements provide a harsh surface that can dislodge particles from the footwear.

The yarn as disclosed and taught herein may be made of multiple components where at least one component has a higher melting temperature than the other components. For example, one component may be nylon 66 while another component may be polytrimethylene terephthalate (PTT). Nylon 66 has a melting temperature of 264° C. (507°F), while PTT has a lower melting point of 228° C. (442° F.). A multicomponent yarn made with these two components will have one component with a higher melting temperature than the other.

On the other hand, the melting point of polypropylene (PP) occurs in a range. Isotactic PP has a melting point of 171° C. (340 ° F.), while commercial isotactic PP has a melting point that ranges from 160 to 166° C. (320-331° F.). Syndiotactic PP with a crystallinity of 30% has a melting point of 130° C. (266° F.). A multicomponent yarn made with these the components of PP and nylon 66 will have one component with a higher melting temperature than the other even if one of the components melts in a range of temperatures.

The same may be applied to multicomponent yarn made with more than two components as well. For example, a multicomponent yarn may be made of nylon 66, PP, and nylon 6, where nylon 6 has a melting temperature of 218.3° C. (425° F.). In this embodiment, when heated the PP will melt first and the nylon 6 second. If the yarn is heated to a temperature above 218.3° C. but below 264° C., the PP and nylon 6 will melt and leave the nylon 66 unmelted. Alternatively, if the yarn is heated to a temperature above 171° C. but below 218.3° C., then the PP will be softened and/or melted leaving the nylon 6 and nylon 66 in its original state.

In a first embodiment, all of the filaments in the yarn may be monofilaments where the filaments of the higher melting polymer are interspersed with filaments of the lower melting polymer, or polymers. This may be depicted in FIG. 2, which is a cross-sectional view of a yarn 200. In this view, five filaments 201 of higher melting polymer are embedded within a plethora of filaments 202 made from a lower melting polymer. In this embodiment, the filaments may be the same size, or the filaments of the higher melting polymer may have a larger or smaller diameter than the filaments of the lower melting polymer.

In another embodiment, the multicomponent yarn may be made of filaments of a core and sheath arrangement. The higher melting polymer, or polymers, may be in the core so that the lower melting polymer, or polymers, may soften and/or melt when heated. That is to say that in the three-component example just given, having first filaments with nylon 6 in a core with PP in the sheath, mixed with second filaments with nylon 66 in the core with PP in the sheath, and heating the yarn to a temperature above 171° C. but below 218.3° C., will soften the PP sheaths leaving the nylon 6 and nylon 66 cores unmelted. The softened PP sheaths may viscidly seep in that molten state.

This embodiment may be illustrated in different ways. For example, FIG. 3 illustrates a cross-section of a yarn 300, where trilobal filament cores 301 are made of higher melting polymer, and where the sheaths 302 are made from the lower melting polymer. Similarly, FIG. 4 illustrates the cross-section of a yarn 400 where the cores 410 of round core and sheath filaments are made of higher melting polymer and the sheathes 402 are made of a lower melting polymer.

In another embodiment, ends of filaments (also known as slivers or bundles of filaments) may be put together to make a multicomponent yarn, such that one or more end is of the higher melting polymer and one or more end is of the lower melting polymer. The ends may be bound together in any way known to those of skill in the art including, but not limited to air entangling, crimping, and twisting. In some embodiments, the ends may be texturized before combining into yarns while in other embodiments, the ends may be assembled into a combination yarn before the yarn is texturized.

A multicomponent yarn 500 made of ends of higher and lower melting polymers may be illustrated in FIG. 5. An end of higher melting polymer 501 may be contained in the yarn 500 along with two ends of lower melting polymer 502 A/B.

In any combination disclosed herein, and in other combinations that are known to those ordinarily skilled in the art, the multicomponent yarn may then be tufted into a primary backing.

The primary backing may be of any woven or nonwoven matrix as are known to those skilled in the art. In one embodiment, it may be preferable to have the primary backing made of a material that melts at a temperature that is higher than the melting temperature of all of the polymers in the filaments in the multicomponent yarn. In other embodiments the primary backing may have components that have different melting points.

In tests performed, Applicant has found that a multicomponent yarn made of filaments of nylon 66 and filaments of PP could be tufted through a primary backing made of woven post-consumer recycled (PCR) PET fiber which is needled and then calendared. The tufting of this multicomponent yarn was found to be easier than tufting a yarn made of only nylon 6 in that it has a lower tenacity and a lower resistance to going through the creeling systems and tufting needles.

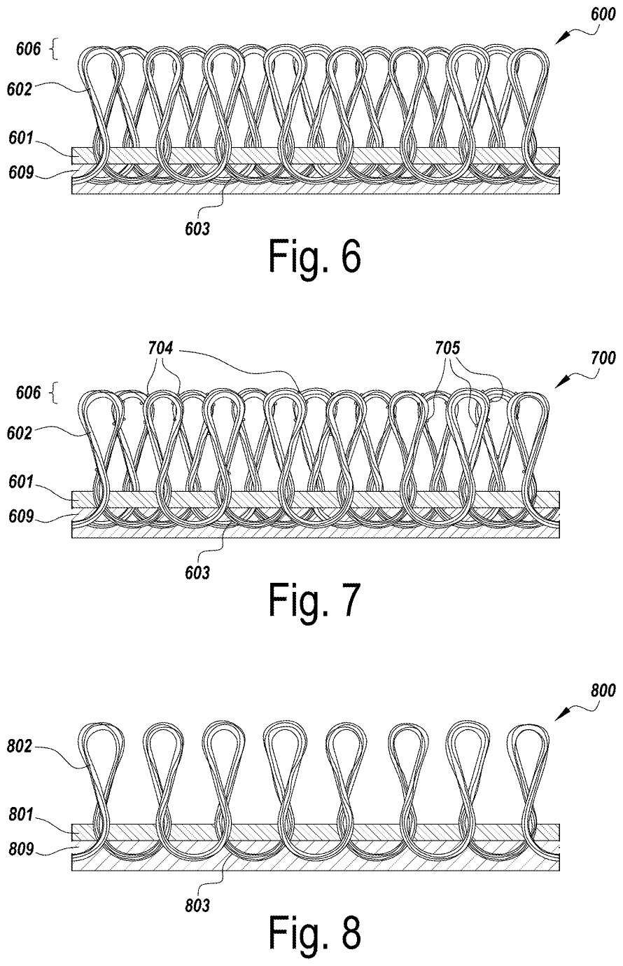

This may be illustrated in FIG. 6 where a yarn 602 has been tufted through a primary backing 601. In this illustrative and non-limiting embodiment, the yarn 602 may be made of ends of filaments similar to that illustrated in FIG. 5. That is to say that the yarn 602 may be comprised of an end of higher melting filaments such as nylon 6 and an end of lower melting filaments such as PP. In this exemplary embodiment, the backstitching 603 is on the underside, or back, of the primary backing 601. The crowns 606 are shown as being above the backing 601 as would appear if the carpet is laid on a horizonal surface such as a floor. However, during manufacturing, the crowns 606 would face downwards as the carpet is being moved through the conveying oven, while a latex backing 609 may be added to the primary backing 601, which would be facing upwards in the oven.

In these tests, the yarn was made of one end of nylon 6 and two ends of PP. The end of nylon 6 was 1800 denier and each of the ends of PP were 900 denier. The ends were air entangled before tufting.

After the yarn was tufted through the primary backing, the griege product was coated with a latex backing and was tenured into a conveying oven in a face-down orientation and subjected to heat from below. That is to say that the liquid latex was applied to the underside of the primary backing while the side of the primary backing with the pile was face-down. The heat partially melted the PP in the face yarn such that it became molten. The carpet was moved at a rate through the conveying oven such that each portion of the carpet was inside the oven for a period of between 10 and 15 minutes. At the entry to the conveying oven, the temperature was at or about 410° F. (210° C.). At the exit of the oven, the temperature was at or about 350° F. (177° C.). This amount of time was configured to allow the latex to cure and was found to be sufficient to heat the PP to a desired degree. The maximum temperature of the oven was therefore between the melting temperatures of the higher melting polymer and the lower melting polymer.

In some areas, the heat from this process allowed portions of some of the PP filaments to melt or partially melt and viscidly migrate towards and gather at the crowns of the tufts. In other areas, the heat from the process allowed some of the PP filaments to fuse together and/or to fuse around other filaments at or near their crowns. In other areas, the process allowed some of the PP from the filaments to fuse at or around nearby filaments of nylon 6. The result was that the face of the carpet exhibited a hand feel that was markedly coarser than a hand feel of a similar griege product that did not have heat applied to soften and/or melt or partially melt some of the PP.

Also, in some areas, the heat from this process allowed portions of some of the PP filaments to melt or partially melt and viscidly migrate towards and gather between the tufts. In other areas, the heat from the process allowed some of the PP filaments to fuse together and/or to fuse around other filaments below the crowns of the loops. In other areas, the process allowed some of the PP from the filaments to fuse at or around nearby filaments of nylon 6. The result was that the pile of the carpet was markedly more rigid and resilient than a pile of a similar griege product where the yarn did not have heat applied to soften and/or melt or partially melt some of the PP. That is to say that the pile of the heat treated griege product was more resistant to crushing and sprang back upwards quicker after being pressed down than a comparative griege product that had not been so treated.

The back of the primary packing still had backstitches with the filaments of unmelted PP. That is to say that the primary backing was still intact and underwent no changes from the heat.

To complete the carpet, a polyolefin backing was adhered over the latex backing 609 of the carpet to provide further stability and weight.

FIG. 7 illustrates a griege product 700 that has been treated to produce a walk-off carpet using the components and methods as disclosed and taught herein. In this illustrative embodiment, some portions of the lower melting polymer had softened and melded with other filaments, or they had melted and migrated towards the crowns 606 of the loops. In the illustrative embodiment of the conducted tests, the yarn 602 may have been made of ends of PP as the lower melting polymer and ends of nylon 6 as the higher melting polymer.

In some of the spaces between the loops 602 of tufted yarn, some of the lower melting polymer had melted and moved towards the crowns 606. When cooled, these globules 704 sit near the crowns 606. Some of the globules 704 may have been an individual drop still connected to the end from which it formed, or some of the polymer may have fluidly moved to adjoin with filaments from another end. In other spaces between the tufts, some of the lower melting polymer may have melted to form globules 705 deeper in the pile. Similar to the globules 704 near the crowns 606, these globules may be individual and still adhering to the end from which they formed, or they may have migrated to adjoin with filaments from another end.

In the embodiment where heat is exposed to the loops 602 of the griege product 700 while the griege product 700 is upside down, the lower melting polymer is not allowed to pool towards the primary backing 601, but remains either at the crowns 606, or between the loops 602. During this heating stage, when the griege product 700 is held with the yarn facing the ground, the lower melting polymer begins to melt and is subjected to interaction forces between it and the high melting filaments by a wicking effect, which may distribute the lower melting polymer along the lengths of the higher melting polymer filaments. Additionally, the force of gravity is pulling the melted lower melting polymer away from the primary backing 601 and towards the crowns 606.

In this exemplary embodiment, the forces between the portions of melted polymer and the nylon cause the molten polymer to become entrained in the filament bundle thus connecting all of the filaments within the yarn bundle and also from one end of the loop to the other. This also allows for different loops to be bound together. This inter-fiber binding adds supporting structure to the tuft so that it becomes more rigid and more difficult to crush underfoot. When it is crushed underfoot, it exhibits a greater resiliency such that it applies a greater force in springing back to an upright position than a loop that does not have any supporting structure.

At the crowns, the globules formed after the lower melting polymer has melted, oozed, and cooled provide irregularly shaped structures. In some instances, the globules form around the filaments of higher melting polymer while in other instances, the globules are from the lower melting polymer fusing and/or binding together. In both instances, the globules at the crowns act as scraper elements. In this, the globules may exhibit coarse textures and irregular shapes as the molten or partially molten polymer cools and solidifies. These coarse textures and irregular shapes may interact with particles of dust and dirt on shoes to loosen and tear away the particles from the footwear.

The result is an increased harshness at the surface and increased rigidity in the pile allowing for an increased frictional property of scraper elements when in contact with articles crossing the carpet, such as shoes or other footwear walking across the carpet.

The formation of the globules may be controlled by the application of more, or less heat applied to the pile side of the griege product. That is to say that if a stiffer and more rigid pile is desired, then heat at a temperature greater than the melting temperature of the lower melting polymer may be applied throughout the time that the griege product spends in the conveying oven. This will allow the heat to permeate through the loops and melt the lower melting polymer between the loops. However, if more scraper elements are desired at the crowns of the loops, then bursts of heat may be focused at the crowns to melt the lower melting polymer there such that the heat does not permeate into the spaces between the loops. Those of ordinary skill in the art and in possession of this disclosure and its teachings will be able to arrive at a product that has desirable rigidity from structure between the loops and desirable scraper elements at the crowns of the loops with little experimentation.

In the tests conducted, the surface globules 704 and the pile globules 705 may be felt but are not visible without magnification. Even without being able to visibly identify the globules, a difference may be felt in that the tufts are stiffer and more rigid, and the upper portions of the loops, including the crowns, provide scraper elements.

While the illustrative embodiments heretofore have been disclosed as comprising filaments of a higher melting polymer, envisioned embodiments are not limited to that. In envisioned embodiments, the component of a higher melting filament may be replaced by, or augmented with, a component of a natural fiber. That is to say that an embodiment of the disclosures and teachings contained herein may encompass a yarn comprised of an end of filaments of a lower melting polymer, an end of filaments of a higher melting polymer, and an end of cotton filaments. Similarly, a yarn may be comprised of an end of a natural fiber and an end of a lower melting polymer.

In any disclosed embodiment and those that may be envisioned by those of ordinary skill in the art and in possession of this disclosure and its teachings, at least one of the filaments in the yarn may be able to wick up moisture. In that illustrative embodiment, the resulting carpet may become a combination walk-off carpet with scraper and stiffening elements and a moisture absorbing mat. Similarly, at least one component may be electrically conductive so that the mat has anti-static properties. Those of skill in the art and in possession of this disclosure may envision other characteristics and properties of mats by using the teachings contained herein without departing from the spirit of the matter claimed.

In an envisioned alternative embodiment, the scraper elements of a walk-off carpet may be made of stiff filaments having a large cross-section. In some embodiments, this may be an end of 6 or 8 filaments of 1500 to 2000 denier nylon. A yarn of these filaments would be very difficult to tuft through a backing. However, as disclosed and taught herein, a yarn of core and sheath filaments with that nylon as the core and a relatively thin sheath of a lower melting polymer may be much easier to creel and tuft.

In an illustrative embodiment of FIG. 8, a griege product 800 may be made of a yarn 802 comprised of core and sheath filaments FIG. 4. It must of course be known that any of the other disclosed or envisioned yarns may also be used to illustrate the concept. In FIG. 8, yarn 802 is tufted through the backing 801.

In this illustrative exemplary embodiment, the griege product may be processed in a conveying oven with enough heat applied to soften and/or melt the lower melting polymer of the sheaths to stiffen the pile and to create scraper elements. Such does not have to be the case in all embodiments. In some embodiments, it may be preferable to melt a portion of the lower melting polymer so that the lower melting polymer flows away leaving only the tops of the filaments of the higher melting polymer exposed. This would leave a bulk of lower melting polymer still in place between the exposed scraper filaments and some amount of sheaths still in the yarn. This bulk in the tufted yarn may provide additional support to keep the scraper filaments in a fully upright orientation while shoes walk across the walk-off carpet.

In an envisioned embodiment, the griege product may be oriented face up with a heat source applied from above. In this embodiment, the filaments of the lower-melting polymer would melt and flow downwards into the primary backing. This may leave the scraper filaments exposed from the primary backing to the top of the pile. In some embodiments, the heat may be applied such that some globules are left between scraper filaments and at the crowns of the pile.

In this embodiment, the material of the primary backing may be made of multicomponent filaments that have some components with similar melting points. For example, a primary backing may be made of filaments of polyethylene terephthalate (PET), which has a melting temperature of 260° C. (500° F.), that are interspersed with filaments of coPET, which may have a melting temperature as low as 110° C. (230° F.). The yarn may be made of filaments of nylon 6 interspersed with filament of coPET. When oriented face up and heated from above, the coPET may melt off of the tufting yarn and flow into the primary backing. If the temperature is controlled to reach the primary backing, but not the backstitching, then the melting coPET from the filaments may join with the melting coPET in the primary backing. When the griege product is removed from the oven, the melted coPET may solidify at the layer of the primary backing thereby securing the backstitching and nylon 6 filaments in place.

In some embodiments, it may be preferable to only partially melt away the filaments of the lower melting polymer. Heat applied to the pile of the griege product will still expose the upper portions of the filaments made with the higher melting polymer. The exposure of the top portions of the scraping filaments may be preferred if it is desirable to keep the lower portions of the filaments of the lower melting polymer to maintain the appearance and feel of bulk throughout the carpet or mat. In some embodiments, maintaining the bulk at the lower portions of the pile may aid in keeping the scraper filaments upright and contacting the soles of shoes to a greater extent. It may also amplify the force that the scraper filament exerts on the soles of shoes as the bulk of the lower portions of the pile may act as a spring to push the scraper filaments against the soles of shoes walking across the mat.

In this embodiment, if desired, heat may also be applied on the back of the primary backing to partially melt the coPET in the yarn with the coPET in the backing to even further secure the tufts in place.

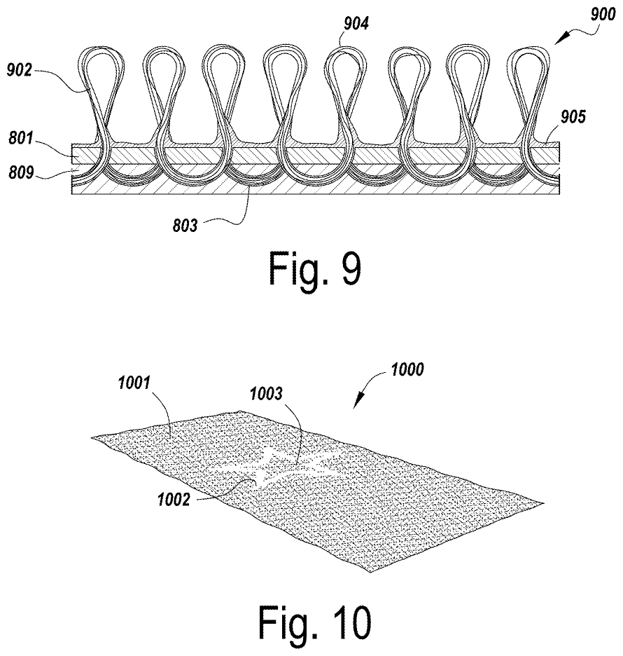

In an illustrative embodiment of FIG. 9, the lower melting polymer 905 that had been the sheath has been melted away thereby exposing a majority of the scraper filaments 904. Some of the lower melting polymer 905 has flowed down to the primary backing 801 thereby further securing the scraper filaments 904 to the primary backing 801. In this illustrative embodiment, the backstitching 803 has not been affected by the heat and remains undisturbed.

In some embodiments, a secondary backing 809 may be adhered to the back of the griege product. Similarly, other processes may be performed on the griege product to finish it.

In some prior art walk-off mats, a heavy secondary backing may have been added to fully secure the tufts in place. Besides being heavy, some have also been impervious to moisture which traps moisture in the mat and also under the mat. In an embodiment where the lower melting polymer, or polymers, are allowed to flow towards the primary backing and thus secure the tufts to the backing, a lower weight secondary backing may be used. In some cases, this secondary backing may also be porous so that water is allowed to seep through the mat. In that embodiment, moisture below the mat may also be allowed to evaporate upwards through the mat. In a location where trapped moisture below the mat may cause mildew or mold problems, allowing moisture under the mat to evaporate through the mat may ameliorate that condition.

Some prior art walk-off mats that have exposed scraper yarn are black in color. In some prior art walk-off mats, the secondary backing is black, the primary backing is black, and the yarn is black. While this may have been a traditional feature of some walk-off mats, Applicant has found ways to use the inventions disclosed and taught herein to make walk-off mats with colors and colored patterns.

In one embodiment, the filaments of the yarn with a higher melting temperature may be of a different color than the filaments of the yarn with a lower melting temperature. In the embodiment where the griege product is oriented face up and the heat source is applied from above, then the lower melting polymer will flow towards and pool at the primary backing. This will expose the color of the higher melting temperature filaments while the color of the lower melting polymer flows towards the primary backing. In some embodiments, the lower melting polymer from the yarn will coat the surface of the primary backing. This will give an appearance of the color of the filaments with a higher melting temperature as standing out against a background color of the lower melting polymer as it lays on the surface of the primary backing.

In another embodiment where the griege product is face down and the heat is applied from below, the color of the lower melting filaments may be removed leaving the color of the filaments of the higher melting polymer exposed above the color of the primary backing.

The concepts disclosed and taught herein may be applied to producing patterns on the faces of mats. For example, in some areas of a mat, the lower melting polymer of the yarn may be fully melted away and allowed to melt away from the griege product, which would leave the colors of the filaments of the higher melting polymer atop the color of the primary backing. In other areas, the lower melting polymer of the yarn may only be partially melted away from the filaments of the higher melting polymer and allowed to melt towards the primary backing. This would leave portions of the griege product with the colors of the filaments of the higher melting polymer with the colors of the filaments of the lower melting polymer atop the color of the lower melting filaments laying on the primary backing.

An illustrative embodiment of this may be seen in FIG. 10. In this exemplary embodiment, a walk-off carpet 1000 may be made. In this, a primary backing may be provided having a navy-blue color. The yarn may be comprised of scraper filaments of navy-blue nylon 6 with white PP filaments. A design may be made of an inner star 1003 within an outer star 702 in a background field 1001. The yarn may be tufted to fill the entire carpet 1000. Heat may be applied to melt away the PP from the backing outside of the outer star 1002 and over the inner star 1003. If all of the PP is melted away, this will leave the field 1001 and the inner star 1003 having a color of navy-blue backing and navy-blue scraper filaments, while the outer star 1002 maintains a white color.

Many other patterns and designs may be made using all of the processes disclosed and taught herein without departing from the spirit of the inventions claimed.

### Conclusion

The present invention is in no way limited to the herein above-described embodiments. On the contrary many such products may be made using yarns comprised of higher melting and lower melting polymers in many configurations where the lower melting polymer (or polymers) are partially melted and cooled to provide rigidity to the pile and scraper elements.

1. A walk-off mat, comprising:
a backing comprising a face and a back;
a yarn comprising filaments of a first polymer mingled with filaments of a second polymer; wherein:
the second polymer has a lower melting temperature than the first polymer;
the yarn is tufted through the backing, such that a first portion of the yarn is a loop and is disposed on the face of the backing and a second portion of the yarn comprises a backstitching and is disposed on the back of the backing;
a crown of the loop is disposed at a location that is distal from the face of the backing;
the crown of the loop comprises at least one scraper element comprised of a globule of the second polymer.

2.-7. (canceled)

8. The walk-off mat of claim 1, wherein the globule is situated between the loop and a second loop.

9. The walk-off mat of claim 8, wherein the first polymer comprises nylon.

10. The walk-off mat of claim 9, wherein the second polymer comprises polypropylene.

11. A walk-off mat comprising:
a backing comprising a face and a back;
a yarn comprising a plurality of bicomponent filaments of a first polymer in a core and a second polymer is a sheath; wherein:
the second polymer has a lower melting temperature than the first polymer;
the yarn is tufted through the backing, such that a portion of the yarn is a loop and is disposed on the face of the backing, and a second portion of the yarn comprises a backstitching and is disposed on the back of the backing;
a crown of the loop is disposed at a location that is distal from the face of the backing;
the crown of the loop comprises at least one scraper element comprised of a globule of the second polymer.

12.-17. (canceled)

18. The walk-off mat of claim 11, wherein the globule is situated between the loop and a second loop.

19. The walk-off mat of claim 18, wherein the first polymer comprises nylon.

20. The walk-off mat of claim 19, wherein the second polymer comprises polypropylene.

21.-34. (canceled)

35. A walk-off mat, comprising:
a backing comprising a face and a back;
a yarn comprising a plurality of bicomponent filaments of a first polymer in a core and a second polymer is a sheath; wherein:
the second polymer has a lower melting temperature than the first polymer;
the yarn is tufted through the backing, such that a portion of the yarn is a loop and is disposed on the face of the backing, and a second portion of the yarn comprises a backstitching and is disposed on the back of the backing;
a crown of the loop is disposed at a location that is distal from the face of the backing;
the crown of the loop comprises at least one scraper filament comprised of an exposed core of at least one bicomponent filament of the plurality of bicomponent filaments.

36.-38. (canceled)

39. The walk-off mat of claim 35, wherein the first polymer comprises nylon.

40. The walk-off mat of claim 39, wherein the second polymer comprises polypropylene.

41.-54. (canceled)

55. The walk-off mat of claim 10, wherein the secondary backing is porous.

56. The walk-off mat of claim 55, wherein the mat comprises an electrically conductive component.

57. The walk-off mat of claim 56, wherein the secondary polymer is pooled at the face.

58. The walk-off mat of claim 20, wherein the secondary backing is porous.

59. The walk-off mat of claim 58, wherein the mat comprises an electrically conductive component.

60. The walk-off mat of claim 59, wherein the secondary polymer is pooled at the face.

61. The walk-off mat of claim 40, wherein the secondary backing is porous.

62. The walk-off mat of claim 61, wherein the mat comprises an electrically conductive component.

63. The walk-off mat of claim 62, wherein the secondary polymer is pooled at the face.
